(19) United States
(12) Patent Application Publication
(10) Pub. No.: US 2013/0049631 A1
(43) Pub. Date: Feb. 28, 2013

(54) LED LAMP WITH VARIABLE DUMMY LOAD

(71) Applicant: Scott A. Riesebosch, St. Catharines (CA)

(72) Inventor: Scott A. Riesebosch, St. Catharines (CA)

(21) Appl. No.: 13/215,761

(22) Filed: Aug. 23, 2011

(51) Int. Cl. H05B 37/02

(52) U.S. Cl. 315/291

(57) ABSTRACT

A minimum operating point of a dimmer is detected, and power is directed away from an LED when a setting of the dimmer approaches the minimum operating point, thereby extending a range of the dimmer.

### TECHNICAL FIELD

Embodiments of the invention generally relate to LED lamps and, in particular, to the use of triac dimmers therewith.

### BACKGROUND

Dimmer switches are used in many lighting applications, and most modern dimmer switches are triac-based. A triac, or bidirectional triode thyristor, is a semiconductor device that conducts current in either direction between its two main terminals only if a voltage on a third terminal, or gate, is raised above a threshold. A potentiometer controlled by a dimmer switch may be used to adjust at what point during an AC cycle the voltage on the gate reaches the threshold; if the potentiometer is set to a low resistance, the threshold is reached quickly, and if set to a high resistance, more slowly. If the triac is connected in series with a light source, the light source receives a portion of each cycle of an input AC waveform only after the triac's gate threshold is reached and the triac begins to conduct or “fires.” The later in each cycle the triac fires, the less of the AC cycle is applied to the light source, and the more it is dimmed.

After the gate voltage threshold is reached, the triac remains in a conducting or “running” state as long as the current flowing between its two main terminals remains above a minimum value. Once the triac current falls below this minimum or “hold” current, the triac switches off and cannot be switched back on until the gate voltage once again exceeds the threshold. Traditional lighting elements (e.g., incandescent lamps) have a fixed, relatively high resistance and present enough of a load to a power source (e.g, AC mains) to draw at least the hold current through the triac. Unlike incandescent lamps, LEDs are nonlinear devices and may, at times, draw less than the hold current. Some LED systems employ a non-light-emitting or “dummy” load in parallel with the LED to ensure the minimum hold current is met; more sophisticated designs may even detect when the LED current is about to dip below the hold current and switch in the dummy load dynamically.

Use of this type of dummy load, however, does not affect the minimum phase angle of the dimmer, below which the triac ceases to fire. For example, when the triac is operating at medium or bright dimmer settings, the brightness of the light source may be approximately linear with respect to the position of the dimmer switch as it chops more or less of the AC waveform. At low-light dimmer settings, however, the resistance of the potentiometer may be so great that it prevents the voltage on the gate of the triac from ever reaching the threshold value; thus, the triac never fires and is off for the entire AC cycle. The dimmer setting at which the triac transitions from running to not running—i.e., from firing late in the AC cycle and producing a dim lamp to not firing and producing an off lamp—produces a nonlinear “jump” in the output of the dimmer.

Traditional light sources (e.g., incandescent lamps) are less sensitive to low-voltage inputs, and a user may not perceive a jump in brightness corresponding to the jump in dimmer output. LED lamps, on the other hand, may remain relatively bright even if a low-voltage input is applied. Their use with a dimmer switch may frustrate a user because, due to the minimum phase angle of the dimmer, the LED light will not seem to be “dim enough” before it switches off entirely. In prior-art systems, if a dimmer is running, it will conduct for a minimum of approximately 500 μs is per AC half-cycle, and thus assume a minimum of approximately 5% of its total brightness before it switches off and jumps to 0%. Thus, a need exists for a circuit that is capable of dimming an LED to a lower light level.

### SUMMARY

In general, various aspects of the systems and methods described herein relate to a circuit that detects a minimum phase angle of a triac-based dimmer switch used to control an LED-based lighting source. When the circuit senses that the dimmer switch is approaching its minimum phase angle, the circuit begins to change an effective resistance of a variable non-light-emitting or dummy load in series or parallel with the LED. The dummy load draws off a portion of the power that would otherwise be applied to the LED, thus allowing it to dim further than it otherwise would. As the dimmer approaches and exceeds its minimum phase angle, the effective resistance of the dummy load changes (e.g., rises or falls) to draw off more power from the LED. By varying the effective resistance of the dummy load appropriately (by, e.g., controlling a variable resistance element, by the use of pulse-width modulation, or by any other means), the circuit allows the LED to be smoothly dimmed down to a lower or an off value without a discontinuity or abrupt dip/jump in brightness.

Accordingly, in one aspect, a circuit modifies a behavior of an LED lamp in response to a received signal from a dimmer. A sensor detects a minimum operating point of the dimmer based at least in part on the received signal. Other circuitry directs power away from an LED when a setting of the dimmer approaches the minimum operating point.

In various embodiments, modifying the behavior of the LED lamp includes extending an operating range of the received dimmer signal. A non-light-emitting load may receive the power directed away from the LED. The non-light-emitting load may include a variable resistor, a variable reactance, or a semiconductor. A pulse-width-modulating circuit may vary an effective resistance of the non-light-emitting load. The minimum operating point may correspond to a minimum phase angle of the dimmer, and the sensor may include a minimum-phase-angle detector (which may monitor a phase angle of the dimmer). A register may store a minimum detected phase angle. The minimum-phase-angle detector may compare a detected phase angle to a value stored in the register and/or compute a minimum phase angle based at least in part on detected non-minimum phase angles.

The sensor may include a minimum-power detector, which may detect power applied to the LED. A register may store a minimum detected power. The circuitry for directing power away from the LED may engage when the LED reaches a threshold of its maximum brightness.

In general, in another aspect, method extends an operating range of an LED lamp in response to a received signal from a dimmer. Power is directed away from an LED when a setting of the dimmer approaches a minimum operating point.

In various embodiments, a minimum operating point of the dimmer is detected based at least in part on the received signal. Directing power away from the LED may extend a range of the dimmer. The power directed away from the LED may be applied to a non-light-emitting load. Detecting the minimum operating point may include detecting a minimum phase angle of the dimmer, which may be stored. The stored phase angle may be compared with a current detected phase angle. Detecting the minimum operating point may include detecting a minimum power applied to the LED; the detected minimum power may be stored and/or compared with a current detected power.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and may exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a block diagram of a system for dynamically adjusting an effective resistance of a dummy load in response to a dimmer setting in accordance with an embodiment of the invention;

FIG. 2 is graph illustrating brightness of an LED with respect to a dimmer switch position in accordance with an embodiment of the invention; and

FIG. 3 is a flowchart of a method for dynamically adjusting an effective resistance of a dummy load in response to a dimmer setting in accordance with an embodiment of the invention.

### DETAILED DESCRIPTION

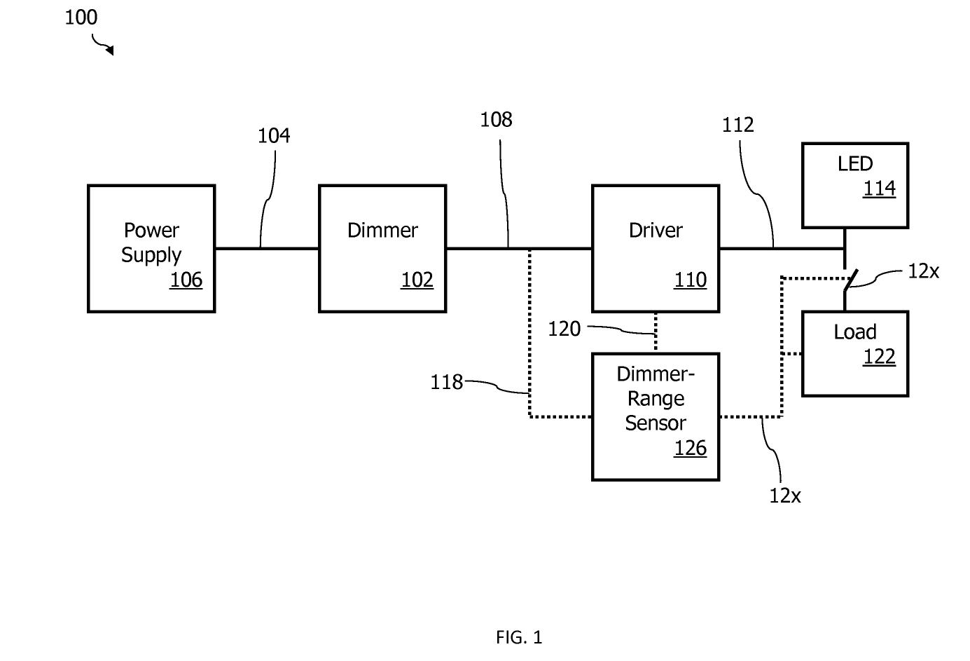

Described herein are various embodiments of methods and systems for detecting a minimum phase angle of a dimmer switch and smoothly dimming an LED light, by varying an effective resistance of a non-light-emitting load, when the dimmer switch approaches the minimum phase angle. One embodiment of such a system 100 is shown in FIG. 1. A dimmer 102 receives a power signal 104 from a power supply 106. The dimmer 102 may be a triac-based dimmer or any dimmer having a minimum phase angle below which the dimmer shuts off. The power supply 106 may be an AC mains supply or any other type of AC source. The dimmer cuts portions of the phase from the power signal 104 to produce a phase-cut or dimmed signal 108. The dimmer 102 may be a leading-edge dimmer (and selectively remove a portion of the leading edge of each phase of the power signal 104) or a trailing-edge dimmer (and selectively remove a portion of the trailing edge of each phase of the power signal 104).

A driver 110 receives the dimmed signal 108 and converts it into an LED power signal 112 suitable for powering the LED 114. The driver 110 may be any LED driver known in the art, and may include a transformer (magnetic or electronic), a voltage regulator, a current source, a DC-to-DC converter, and/or other components. The implementation of the driver 110 may depend on particular conditions of the implementation, ultimate use of the system 100, and/or characteristics of the LED 114. Embodiments of the current invention are not limited to any single implementation of the driver 110.

A dimmer-range sensor 116 monitors the dimmed signal 108 via an input 118. In other embodiments, the dimmer-range sensor 116 monitors a characteristic of the driver 110 that corresponds to the dimmed signal 108 via a second input 120. The dimmer-range sensor 116 and driver 110 may be discrete units or may be combined into a single unit. The dimmer-range sensor 116 may measure the phase angle of the dimmed signal 108 over a period of time; the minimum detected phase angle may be stored in a register until a lower phase angle is detected, whereupon the register is updated with the lower value. The value stored in the register may be considered the minimum phase angle after the dimmed signal 108 has been observed for, e.g., 30 seconds, five minutes, ten minutes, or any other length of time. The dimmer-range sensor 116 may distinguish between a low minimum phase angle and the dimmer 102 being completely shut off (e.g., a phase angle of zero). In one embodiment, the dimmer-range sensor 116 assumes that the lowest observed nonzero phase angle is the minimum phase angle when a phase angle of zero is subsequently detected.

Alternatively, the dimmer-range sensor 116 may predict the minimum phase angle based on values observed for the phase angle of the dimmer signal 108 when the phase angle is at non-minimum settings. For example, the dimmer-range sensor 116 may observe two or more phase angles at two or more points in time. Using this information, the dimmer-range sensor 116 may determine a rate of change of the phase angle (i.e., an amount of change of the phase angle divided by a change in time). This rate of change may depend on the mechanical precision of the dimmer 102, how quickly a user manipulates a control on the dimmer 102, and/or the sensitivity of circuitry in the dimmer 102 for receiving and interpreting the dimmer-control manipulation. A dimmer 102 having a higher rate of change may have a smaller minimum phase angle (because, for example, the dimmer changes the phase angle so rapidly that a jump in dimmer output caused by a triac shutting off is less noticeable), and a dimmer 102 having a lower rate of change may have a larger minimum phase angle (because the triac has more time to react to each new dimmer setting, potentially shutting off sooner). In one embodiment, the dimmer-range sensor 116 assumes a constant value for the minimum phase angle (e.g., 500 μs).

Instead of or in addition to determining the minimum phase angle of the dimmer 102, the dimmer-range sensor 126 may monitor the power delivered to the LED 114. While power is being delivered, the dimmer 102 may be assumed to be running. When power is not delivered, the dimmer-range sensor 126 assumes that the dimmer 102 is not running. When the dimmer-range sensor 116 detects a transition from power delivery to no power delivery (or vice versa), it may note the power delivered to the LED 114 just prior to, during, or just after the transition. This minimum non-zero power level may be saved in a register (or otherwise stored), and the power delivered to the LED 114 may be monitored for its proximity to the minimum power.

Once the minimum setting of the dimmer 102 is known, either by determining the minimum phase angle of the dimmer 102 and/or by determining the minimum non-zero power delivered to the LED 116, the dimmer-range sensor 116 and/or the driver 110 adjust an effective resistance of a variable non-light-emitting load 122 when the setting of the dimmer 102 approaches the minimum phase angle. In one embodiment, the non-light-emitting load 122 is a variable element such as a variable resistor, a variable reactance, or any other type of variable non-light-emitting load known in the art, and may include a semiconductor material.

In another embodiment, the dimmer-range sensor 116 and/or the driver 110 adjust the effective resistance of the non-light-emitting load 122 though the use of pulse-width modulation (PWM). For example, during higher dimmer settings (i.e., when the dimmer 102 is disengaged or dimming the LED 114 only slightly), the non-light emitting load 122 is not used at all, or used very little, with virtually all the power going to the LED 116. At lower dimmer settings (i.e., when the dimmer 102 attempts to dim the LED 116 to a greater degree), however, instead of directly reducing the resistance of the non-light emitting load 122, the use of PWM may instead “load swap” between the LED 116 and the non-light-emitting load 122. Essentially, the PWM function connects the non-light emitting load 122 for a variable portion of time per PWM cycle; the LED 116 is connected for the remainder of the PWM cycle. The ratio of time that the non-light emitting load 122 is connected to the total period for power delivery (i.e. the time the dimmer 102 is actually delivering power) is the duty cycle of the non-light emitting load 122. This duty cycle increases as the dimmer setting goes lower, causing the LED 116 to dim much more than they regularly would, in accordance with embodiments of the present invention, while still providing a power path for the dimmer 102 to deliver power.

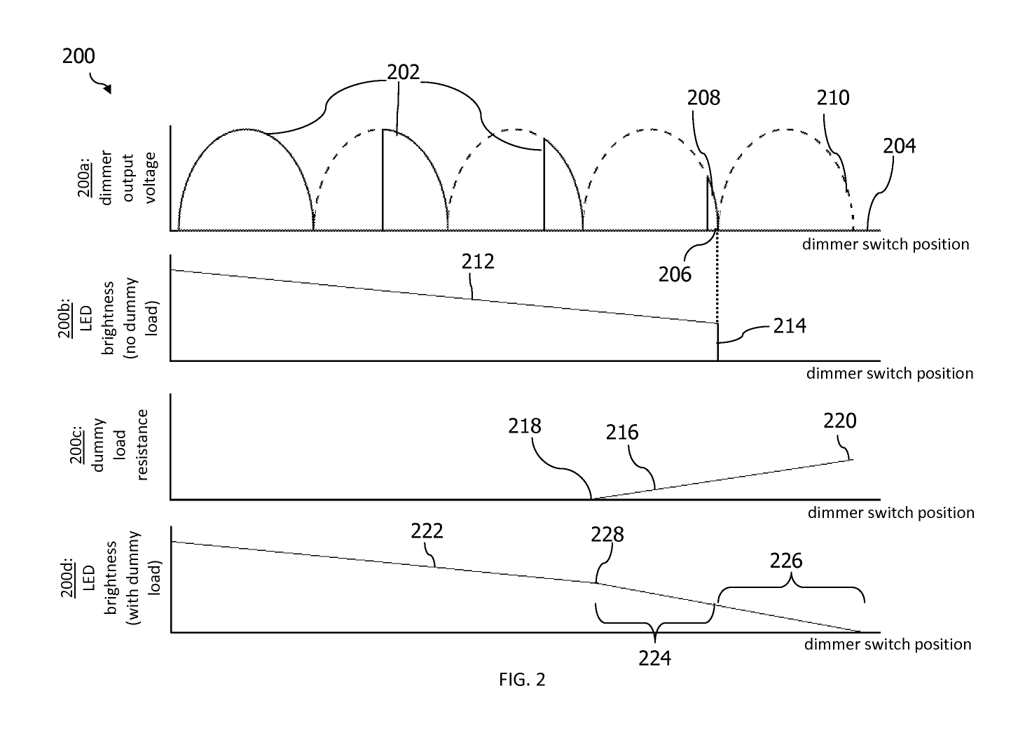

An example of a relationship between the dimmer setting, LED brightness, and the effective resistance of the non-light-emitting load 122 is illustrated by the graphs 200 in FIG. 2. A first graph 200a shows a rectified dimmer output voltage 202 (e.g., the signal 108) varying in accordance with a switch position of a dimmer (e.g., the dimmer 204). At a certain dimmer setting 206, the dimmer output voltage reaches its minimum value 208 before shutting off as indicated at 210.

The brightness 212 of the LED 114, as shown in a second graph 200b, varies with to the dimmer output voltage level 202, 208. As discussed herein, when the triac in the dimmer 102 shuts off, the LED brightness experiences a sudden drop 214 in its output. Note that the LED brightness 212 may not be perfectly linear with respect to the dimmer position, as is shown in FIG. 2, and that the drop 214 may not be so pronounced; the curves in FIG. 2 are simplified to illustrate the operation of embodiments of the current invention and may not represent absolute dimmer output and LED brightness values.

A third curve 200c illustrates the effective resistance 216 of the non-light-emitting load 122 (i.e., its variable resistance and/or its effective resistance as a result of PWM switching) as a function of dimmer switch position. As the dimmer switch nears its point of minimum phase angle 214, the dimmer-range sensor 126 and/or driver 110 begin to ramp up the effective resistance 216 of the non-light-emitting load 122. The effective resistance 216 may begin to rise at a point 218 in advance of the minimum phase angle 214; in other embodiments, the point 218 may coincide with the minimum phase angle 214. The effective resistance 216 reaches a maximum value 220 at a point corresponding to a full-engaged position of the dimmer switch.

The behavior of the effective resistance 216, as shown in the third curve 200c of FIG. 2, may correspond to a circuit in which the non-light-emitting load 122 is in series with the LED 114. Such a circuit may employ a constant-current source (in, e.g., the driver 110) to drive the LED 114, and as the effective resistance 216 increases, it draws more and more power away from the LED 114. Alternatively, the driver 110 may employ a constant-voltage source to drive the LED 114, and the non-light-emitting load 122 may be disposed in parallel with the LED 114. In this case, the maximum effective resistance 220 of the non-light-emitting load 122 may occur at the point of minimum phase angle 214, and the effective resistance 220 may decrease (instead of increase) as the dimmer is adjusted further toward its off position 210. In general, any configuration of non-light-emitting load 122 and LED 114, in which the non-light-emitting load 122 may progressively draw power away from the LED 114, is within the scope of the current invention.

The effect of the non-light-emitting load 122 on the output brightness 222 of the LED 114 is shown in a fourth curve 200d. Because the non-light-emitting load 122 draws power away from the LED 114, the brightness of the LED 114, in a first region 224, is less than it otherwise would be. Because the presence of the non-light-emitting load 122 keeps the triac in the dimmer 102 firing, the range of the dimmer 102 is extended into a second region 226.

The output brightness 222 may experience a nonlinearity or inflection point 228 when the non-light-emitting load 122 begins to vary its effective resistance 216. The inflection point 228 is exaggerated in the fourth curve 200d to illustrate an embodiment of the current invention; in other embodiments, the output brightness 222 is less affected by the variation of the non-light-emitting load 122, and a user does not perceive a difference in the rate of change or “feel” of the dimmer 102 when the non-light-emitting load 122 engages.

The point 218 where the effective resistance of the non-light-emitting load 122 first begins to vary may be adjusted in accordance with user preferences and design considerations. The earlier the non-light-emitting load 122 engages (i.e., further in advance of the minimum phase angle 214), the less difference a user may detect in the behavior of the dimmer 102 (i.e., the inflection point 228 is “smoother”) at the point of engagement 218. Engaging the non-light-emitting load 122 earlier, however, may mean converting a lesser portion of system power into usable light via the LED 114, because more power is spent on the non-light-emitting load 122. Engaging the non-light-emitting load 122 closer to the minimum phase angle 214 means that a greater portion of system power is spent on the LED 114, but also means that a user may experience an abrupt change in the behavior of the dimmer 102 as the load 122 engages. In one embodiment, the point 218 is chosen to provide a compromise between these two considerations. The minimum phase angle 214 may occur at approximately 5% of the LED's maximum brightness; in various embodiments, the load 122 may engage 218 at a threshold (e.g., 50%, 25%, 15%, 10%, or 5%) of maximum brightness.

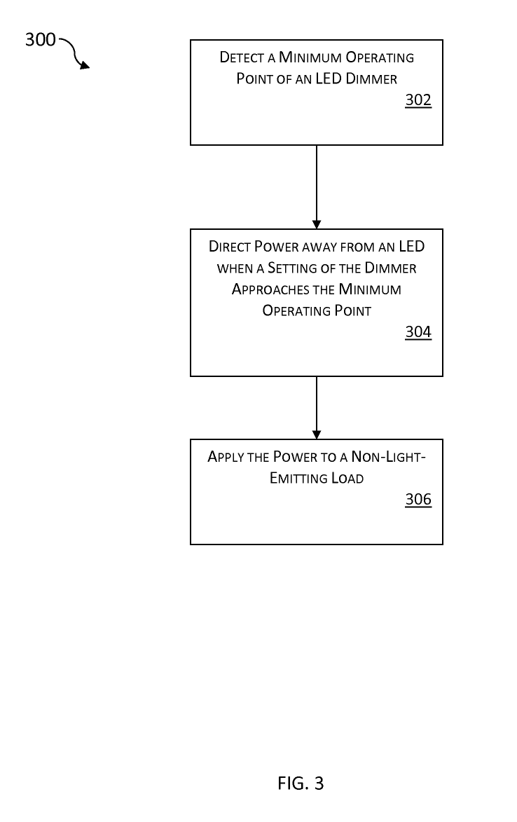

The circuits and systems described above may be used in accordance with the flowchart 300 illustrated in FIG. 3. In a first step 302, a minimum operating point of a dimmer is detected. As described above, the minimum phase angle of the dimmer or minimum power applied to the LED may be used to determine the minimum operating point. In a second step 304, power is directed away from the LED when a setting of the dimmer approaches the minimum operating point. The point at which power begins to be directed away from the LED may vary with a particular implementation of the current invention, from far away from the minimum operating point to very close to, or coincident with, the minimum operating point. In a third step 306, the power is applied to a non-light-emitting load (e.g., a variable resistor).

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A circuit for modifying a behavior of an LED lamp in response to a received signal from a dimmer, the circuit comprising:
a sensor for detecting a minimum operating point of the dimmer based at least in part on the received signal; and
circuitry for directing power away from an LED when a setting of the dimmer approaches the minimum operating point.

2. The circuit of claim 1, wherein modifying the behavior of the LED lamp comprises extending an operating range of the received dimmer signal.

3. The circuit of claim 1, further comprising a non-light-emitting load for receiving the power directed away from the LED.

4. The circuit of claim 2, wherein the non-light-emitting load comprises a variable resistor, a variable reactance, or a semiconductor.

5. The circuit of claim 2, further comprising a pulse-width-modulating circuit for varying an effective resistance of the non-light-emitting load.

6. The circuit of claim 1, wherein the minimum operating point corresponds to a minimum phase angle of the dimmer, and the sensor comprises a minimum-phase-angle detector.

7. The circuit of claim 6, wherein the minimum-phase-angle detector monitors a phase angle of the dimmer.

8. The circuit of claim 6, further comprising a register for storing a minimum detected phase angle.

9. The circuit of claim 8, wherein the minimum-phase-angle detector compares a detected phase angle to a value stored in the register.

10. The circuit of claim 6, wherein the minimum-phase-angle detector computes a minimum phase angle based at least in part on detected non-minimum phase angles.

11. The circuit of claim 1, wherein the sensor comprises a minimum-power detector.

12. The circuit of claim 11, wherein the minimum-power detector detects power applied to the LED.

13. The circuit of claim 12, further comprising a register for storing a minimum detected power.

14. The circuit of claim 1, wherein the circuitry for directing power away from the LED engages when the LED reaches a threshold of its maximum brightness.

15. A method for extending an operating range of an LED lamp in response to a received signal from a dimmer, the method comprising:
directing power away from an LED when a setting of the dimmer approaches a minimum operating point.

16. The method of claim 15, further comprising detecting a minimum operating point of the dimmer based at least in part on the received signal.

17. The method of claim 15, wherein directing power away from the LED extends a range of the dimmer.

18. The method of claim 15, further comprising applying the power directed away from the LED to a non-light-emitting load.

19. The method of claim 16, wherein detecting the minimum operating point comprises detecting a minimum phase angle of the dimmer.

20. The method of claim 19, further comprising storing the detected minimum phase angle.

21. The method of claim 20, further comprising comparing the stored phase angle with a current detected phase angle.

22. The method of claim 16, wherein detecting the minimum operating point comprises detecting a minimum power applied to the LED.

23. The method of claim 22, further comprising storing the detected minimum power.

24. The method of claim 23, further comprising comparing the stored power with a current detected power.
